(19) United States
(12) Patent Application Publication
(10) Pub. No.: US 2022/0216820 A1
(43) Pub. Date: Jul. 7, 2022

(54) DRIVE DEVICE

(71) Applicant: Nidec Corporation, Kyoto (JP)

(72) Inventors: Keisuke FUKUNAGA, Kyoto (JP); Akihiro NITA, Kyoto (JP)

(73) Assignee: Nidec Corporation, Kyoto (JP)

(21) Appl. No.: 17/601,836

(22) PCT Filed: Apr. 17, 2020
(86) PCT No.: PCT/JP2020/016852

§ 371 Date: Oct. 6, 2021

(30) Foreign Application Priority Data
Apr. 19, 2019 (JP) 2019-080342

(51) Int. Cl. H02P 29/60; B60L 15/20; F16H 57/04; B60L 3/00; B60L 1/00

(52) U.S. Cl. CPC H02P 29/60; B60L 15/20; F16H 57/0436; B60L 2240/425; B60L 3/0061; B60L 1/003; F16H 57/0476

(57) ABSTRACT

A drive device that rotates an axle of a vehicle includes a motor, a transmission that includes a decelerator connected to the motor, a housing that accommodates the motor and the transmission, a temperature sensor to detect a temperature of the motor, and a controller to control the motor. Oil supplied to the transmission is accommodated in the housing. The controller limits an output of the motor based on a detection result of the temperature sensor.

### CROSS-REFERENCE TO RELATED APPLICATIONS

This is a U.S. national stage of application No. PCT/JP2020/016852, filed on Apr. 17, 2020, and priority under 35 U.S.C. § 119(a) and 35 U.S.C. § 365(b) is claimed from Japanese Patent Application No. 2019-080342, filed on Apr. 19, 2019; the entire disclosures of which are hereby incorporated herein by reference.

### 1. FIELD OF THE INVENTION

The present disclosure relates to a drive device.

### 2. BACKGROUND

A drive device mounted on a vehicle and accommodating oil in a case is known. For example, a drive device for a hybrid vehicle is known.

In the drive device as described above, there is a case where the oil accommodated in the case is used as lubricating oil for the deceleration device or the like in the drive device. In general, the lower the temperature is, the higher the viscosity of oil becomes. Therefore, the viscosity of oil becomes too high under a relatively low temperature environment, and the oil sometimes becomes less likely to function as lubricating oil for a deceleration device or the like. Therefore, there is a possibility that a failure occurs in the drive device.

### SUMMARY

An example embodiment of a drive device of the present disclosure is a drive device that rotates an axle of a vehicle. The drive device includes a motor, a transmission that includes a decelerator connected to the motor and a differential connected to the motor via the decelerator, a housing that accommodates all of the motor, the decelerator, and the differential, a temperature sensor to detect a temperature of the motor, and a controller to control the motor. Oil supplied to the transmission is accommodated in the housing. The controller limits output of the motor based on a detection result of the temperature sensor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a view showing a functional configuration of a vehicle drive system according to a first example embodiment of the present disclosure.

FIG. 2 is an overall configuration view schematically showing the drive device of the first example embodiment.

FIG. 3 is a flowchart showing an example of a control procedure by the controller of the first example embodiment.

FIG. 4 is a flowchart showing a procedure of operation check of the oil pump by the controller of the first example embodiment.

FIG. 5 is a flowchart showing a procedure of flow rate control of the oil pump by the controller of the first example embodiment.

FIG. 6 is a graph showing an example of a change in a duty ratio with respect to a temperature of a motor in the first example embodiment.

FIG. 7 is a flowchart showing a procedure of after-run control by the controller of the first example embodiment.

FIG. 8 is a flowchart showing a procedure of flow rate control of the oil pump by the controller of a second example embodiment of the present disclosure.

FIG. 9 is a graph showing an example of a change in a duty ratio with respect to a temperature of a motor in the second example embodiment.

### DETAILED DESCRIPTION

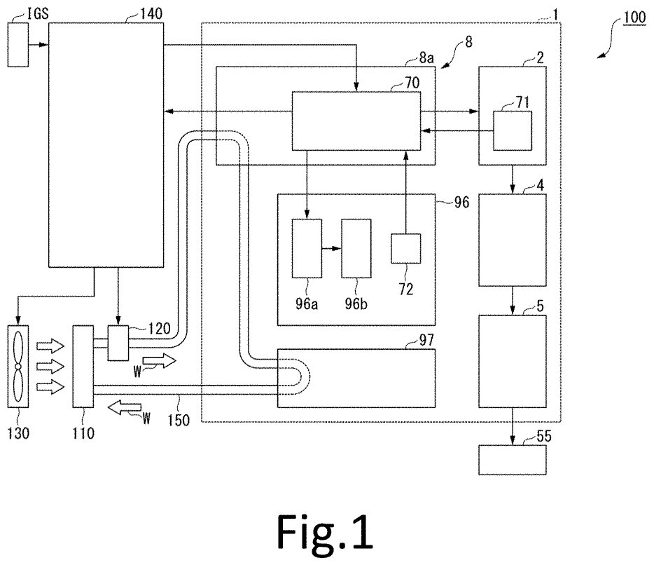

A vehicle drive system 100 shown in FIG. 1 is mounted on a vehicle and drives the vehicle. A vehicle equipped with the vehicle drive system 100 of the present example embodiment is a motor-powered vehicle, such as a hybrid vehicle (HEV), a plug-in hybrid vehicle (PHV), and an electric vehicle (EV). The vehicle drive system 100 includes a drive device 1, a radiator 110, a refrigerant pump 120, a fan device 130, and a vehicle control device 140. That is, the drive device 1, the radiator 110, the refrigerant pump 120, the fan device 130, and the vehicle control device 140 are provided in the vehicle. The radiator 110 cools a refrigerant W. In the present example embodiment, the refrigerant W is, for example, water.

The refrigerant pump 120 is an electricity-driven electric pump. The refrigerant pump 120 sends the refrigerant W from the radiator 110 to the drive device 1 via a refrigerant flow path 150. The refrigerant flow path 150 is a flow path that extends from the radiator 110 to the drive device 1 and returns to the radiator 110 again. The refrigerant flow path 150 passes through the inside of an inverter unit 8 described later and the inside of an oil cooler 97. The refrigerant W flowing through the refrigerant flow path 150 cools a controller 70 described later provided in the inverter unit 8 and an oil O flowing through the oil cooler 97.

The fan device 130 can blow air to the radiator 110. Accordingly, the fan device 130 can cool the radiator 110. The type of the fan device 130 is not particularly limited as long as it can blow air to the radiator 110. The fan device 130 may be an axial fan, a centrifugal fan, or a blower.

The fan device 130 is switched between in a driving state and in a stopping state according to the temperature of the refrigerant W accommodated in the radiator 110, for example. For example, when the vehicle is traveling, a flow of air generated by the traveling of the vehicle is blown to the radiator 110, and the refrigerant W in the radiator 110 is easily cooled. In this case, the fan device 130 is in a stopping state, for example. On the other hand, when the vehicle is stopped, the flow of air as described above is less likely to occur, and hence the refrigerant W inside the radiator 110 can be suitably cooled by blowing air to the radiator 110 with the fan device 130 being in the driving state. Note that the fan device 130 may be constantly in the driving state regardless of the travel state of the vehicle.

The vehicle control device 140 controls each device mounted on the vehicle. In the present example embodiment, the vehicle control device 140 controls the drive device 1, the refrigerant pump 120, and the fan device 130. A signal from an ignition switch IGS provided in the vehicle is input to the vehicle control device 140. The ignition switch IGS is a switch that switches driving and stopping of the drive device 1, and is directly or indirectly operated by the driver who drives the vehicle.

When the ignition switch IGS is switched from OFF to ON, the vehicle control device 140 sends a signal to the controller 70 described later of the drive device 1 to drive the drive device 1 and bring the vehicle into a travelable state. On the other hand, when the ignition switch IGS is turned from ON to OFF, the vehicle control device 140 sends a signal to the controller 70 to stop the drive device 1.

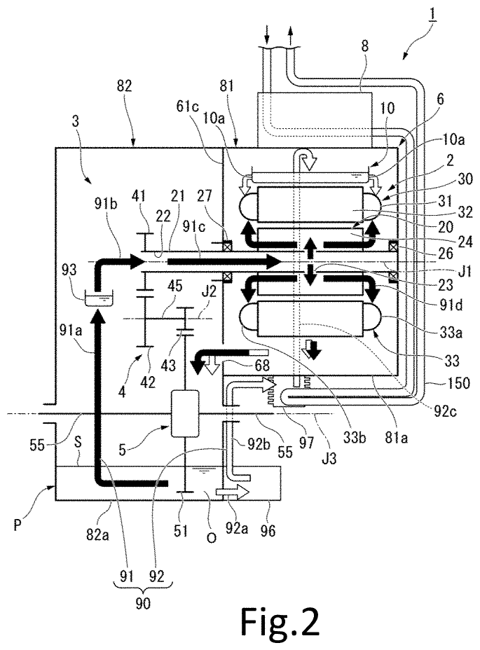

The drive device 1 is used as a power source of a motor-powered vehicle such as a hybrid vehicle (HEV), a plug-in hybrid vehicle (PHV), or an electric vehicle (EV) described above. As shown in FIG. 2, the drive device 1 includes a motor 2, a transmission device 3 having a deceleration device 4 and a differential device 5, a housing 6, the inverter unit 8, an oil pump 96, and the oil cooler 97. The housing 6 accommodates therein the motor 2 and the transmission device 3. The housing 6 has a motor accommodation portion 81 accommodating the motor 2 therein, and a gear accommodation portion 82 accommodating the deceleration device 4 and the differential device 5 therein.

In the present example embodiment, the motor 2 is an inner rotor motor. The motor 2 has a rotor 20, a stator 30, and bearings 26 and 27. The rotor 20 is rotatable about a motor axis J1 extending in the horizontal direction. The rotor 20 has a shaft 21 and a rotor body 24. Although not illustrated, the rotor body 24 has a rotor core and a rotor magnet fixed to the rotor core. Torque of the rotor 20 is transmitted to the deceleration device 4.

In the following description, the horizontal direction in which the motor axis J1 extends is referred to as an “axial direction” (axially), the radial direction about the motor axis J1 is simply referred to as a “radial direction” (radially), and the circumferential direction about the motor axis J1, i.e., around the axis of the motor axis J1 is simply referred to as a “circumferential direction” (circumferentially). In the present example embodiment, the axial direction is the right-left direction in FIG. 2, for example, and is the right-left direction of the vehicle, i.e., the vehicle width direction. In the following description, the right side in FIG. 2 in the axial direction is simply referred to as a “right side”, and the left side in FIG. 2 in the axial direction is simply referred to as a “left side”. In addition, the up-down direction in FIG. 2 is referred to as a vertical direction. The upper side in FIG. 2 is simply referred to as an “up” (upside, upper, upper side, upward) as the vertical direction upper side, and the lower side in FIG. 2 is simply referred to as a “down” (downside, lower, lower side, downward) as the vertical direction lower side.

The shaft 21 extends along the axial direction about the motor axis J1. The shaft 21 rotates about the motor axis J1. The shaft 21 is a hollow shaft provided with a hollow portion 22 inside. The shaft 21 is provided with a communication hole 23. The communication hole 23 extends in the radial direction and connects the hollow portion 22 with the outside of the shaft 21.

The shaft 21 extends across the motor accommodation portion 81 and the gear accommodation portion 82 of the housing 6. The left end of the shaft 21 projects into the gear accommodation portion 82. A first gear 41 described later of the deceleration device 4 is fixed to the left end of the shaft 21. The shaft 21 is rotatably supported by the bearings 26 and 27.

The stator 30 is opposed to the rotor 20 in the radial direction across a gap. More specifically, the stator 30 is positioned radially outside the rotor 20. The stator 30 has a stator core 32 and a coil assembly 33. The stator core 32 is fixed to the inner peripheral surface of the motor accommodation portion 81. Although not illustrated, the stator core 32 has an axially extending cylindrical core back and a plurality of teeth extending radially inside from the core back.

The coil assembly 33 has a plurality of coils 31 attached to the stator core 32 along the circumferential direction. The plurality of coils 31 are attached to the respective teeth of the stator core 32 with an insulator (not illustrated) interposed therebetween. The plurality of coils 31 are arranged along the circumferential direction. More specifically, the plurality of coils 31 are arranged at equal intervals along the circumferential direction throughout the circumference. Although not illustrated, the coil assembly 33 may have a binding member or the like for binding the coils 31, or may have a connecting wire for connecting the coils 31 with one another.

The coil assembly 33 has coil ends 33a and 33b projecting axially from the stator core 32. The coil end 33a is a part projecting to the right side from the stator core 32. The coil end 33b is a part projecting to the left side from the stator core 32. The coil end 33a includes a part projects to the right side relative to the stator core 32 of each coil 31 included in the coil assembly 33. The coil end 33b includes a part projects to the left side relative to the stator core 32 of each coil 31 included in the coil assembly 33. In the present example embodiment, the coil ends 33a and 33b are annular about the motor axis J1. Although not illustrated, the coil ends 33a and 33b may include binding members or the like for binding the coils 31, or may include connecting wires for connecting the coils 31 with one another.

The bearings 26 and 27 rotatably support the rotor 20. The bearings 26 and 27 are, for example, ball bearings. The bearing 26 is a bearing rotatably supporting a part of the rotor 20 positioned on the right side relative to the stator core 32. In the present example embodiment, the bearing 26 supports a part of the shaft 21 positioned on the right side relative to the part to which the rotor body 24 is fixed. The bearing 26 is held by a wall portion covering the right side of the rotor 20 and the stator 30 in the motor accommodation portion 81.

The bearing 27 is a bearing rotatably supporting a part of the rotor 20 positioned on the left side relative to the stator core 32. In the present example embodiment, the bearing 27 supports a part of the shaft 21 positioned on the left side relative to the part to which the rotor body 24 is fixed. The bearing 27 is held in a partition wall 61c described later.

As shown in FIG. 1, the motor 2 has a temperature sensor 71 detectable of the temperature of the motor 2. That is, the drive device 1 includes the temperature sensor 71. In the present example embodiment, the temperature of the motor 2 is, for example, the temperature of the coil 31 of the motor 2. Although not illustrated, the temperature sensor 71 is embedded in, for example, the coil end 33a or the coil end 33b. The type of the temperature sensor 71 is not particularly limited. The detection result of the temperature sensor 71 is sent to the controller 70 described later.

The deceleration device 4 is connected to the motor 2. More specifically, as shown in FIG. 2, the deceleration device 4 is connected to the left end of the shaft 21. The deceleration device 4 reduces the rotational speed of the motor 2 and increases the torque output from the motor 2 according to the reduction ratio. The deceleration device 4 transmits torque outputted from the motor 2 to the differential device 5. The deceleration device 4 has a first gear 41, a second gear 42, a third gear 43, and an intermediate shaft 45.

The first gear 41 is fixed to the outer peripheral surface at the left end of the shaft 21. The first gear 41, together with the shaft 21, rotates about the motor axis J1. The intermediate shaft 45 extends along an intermediate axis J2. In the present example embodiment, the intermediate axis J2 is parallel to the motor axis J1. The intermediate shaft 45 rotates about the intermediate axis J2.

The second gear 42 and the third gear 43 are fixed to the outer peripheral surface of the intermediate shaft 45. The second gear 42 and the third gear 43 are connected via the intermediate shaft 45. The second gear 42 and the third gear 43 rotate about the intermediate axis J2. The second gear 42 meshes with the first gear 41. The third gear 43 meshes with a ring gear 51 described later of the differential device 5. The outer diameter of the second gear 42 is larger than the outer diameter of the third gear 43. In the present example embodiment, the lower end of the second gear 42 is the lowermost part of the deceleration device 4.

The torque output from the motor 2 is transmitted to the differential device 5 via the deceleration device 4. More specifically, the torque output from the motor 2 is transmitted to the ring gear 51 of the differential device 5 via the shaft 21, the first gear 41, the second gear 42, the intermediate shaft 45, and the third gear 43 in this order. The gear ratio of each gear, the number of gears, and the like can be variously changed according to the required reduction ratio. In the present example embodiment, the deceleration device 4 is a parallel axis gear type deceleration device in which the axis centers of the gears are disposed in parallel.

The differential device 5 is connected to the deceleration device 4. Thus, the differential device 5 is connected to the motor 2 via the deceleration device 4. The differential device 5 is a device for transmitting the torque output from the motor 2 to the wheels of the vehicle. The differential device 5 transmits the same torque to axles 55 of the right and left wheels while absorbing the speed difference between the right and left wheels when the vehicle turns. The differential device 5 rotates the axle 55 about a differential axis J3. Thus, the drive device 1 rotates the axle 55 of the vehicle. The differential axis J3 extends in the right-left direction of the vehicle, i.e., the vehicle width direction of the vehicle. In the present example embodiment, the differential axis J3 is parallel to the motor axis J1.

The differential device 5 includes a ring gear 51, a gear housing not illustrated, a pair of pinion gears not illustrated, a pinion shaft not illustrated, and a pair of side gears not illustrated. The ring gear 51 is a gear rotating about the differential axis J3. The ring gear 51 meshes with the third gear 43. Thus, the torque output from the motor 2 is transmitted to the ring gear 51 via the deceleration device 4. The lower end of the ring gear 51 is positioned lower than the deceleration device 4. In the present example embodiment, the lower end of the ring gear 51 is the lowermost part of the differential device 5.

The housing 6 is an outer casing of the drive device 1. The housing 6 has a partition wall 61c axially partitioning the inside of the motor accommodation portion 81 and the inside of the gear accommodation portion 82. The partition wall 61c is provided with a partition wall opening 68. The inside of the motor accommodation portion 81 and the inside of the gear accommodation portion 82 are connected to each other via the partition wall opening 68.

The oil O is accommodated in the housing 6. More specifically, the oil O is accommodated inside the motor accommodation portion 81 and inside the gear accommodation portion 82. A lower region inside the gear accommodation portion 82 is provided with an oil sump P for accumulating the oil O. An oil surface S of the oil sump P is positioned upper than the lower end of the ring gear 51. Thus, the lower end of the ring gear 51 is immersed in the oil O in the gear accommodation portion 82. The oil surface S of the oil sump P is positioned lower than the differential axis J3 and the axle 55.

The oil O in the oil sump P is sent to the inside of the motor accommodation portion 81 through an oil passage 90 described later. The oil O sent to the inside of the motor accommodation portion 81 accumulates in a lower region inside the motor accommodation portion 81. At least a part of the oil O accumulated in the motor accommodation portion 81 moves to the gear accommodation portion 82 through the partition wall opening 68 and returns to the oil sump P.

Note that when “the oil is accommodated in a certain part” in the present specification, the oil is only required to be positioned in a certain part at least in a part when the motor is being driven, and the oil may not be positioned in a certain part when the motor is stopped. For example, when the oil O is accommodated in the motor accommodation portion 81 in the present example embodiment, the oil O is only required to be positioned in the motor accommodation portion 81 at least in part when the motor 2 is being driven, and the oil O in the motor accommodation portion 81 may entirely be moved to the gear accommodation portion 82 through the partition wall opening 68 when the motor 2 is stopped. A part of the oil O sent to the inside of the motor accommodation portion 81 through the oil passage 90 described later may remain inside the motor accommodation portion 81 in a state where the motor 2 is stopped.

In the present description, when “the lower end of the ring gear is immersed in the oil in the gear accommodation portion”, the lower end of the ring gear is only required to be immersed in the oil in the gear accommodation portion at least in part when the motor is being driven, and the lower end of the ring gear may not be immersed in the oil in the gear accommodation portion in part when the motor is being driven or the motor is stopped. For example, as a result of the oil O in the oil sump P being sent to the inside of the motor accommodation portion 81 due to the oil passage 90 described later, the oil surface S of the oil sump P may be lowered, and the lower end of the ring gear 51 may be temporarily not immersed in the oil O.

The oil O circulates in the oil passage 90 described later. The oil O is used for lubrication of the deceleration device 4 and the differential device 5. The oil O is used for cooling the motor 2. As the oil O, an oil equivalent to an automatic transmission fluid (ATF) having a relatively low viscosity is preferably used in order to perform the function of lubricating oil and cooling oil.

A bottom portion 82a of the gear accommodation portion is positioned lower than a bottom portion 81a of the motor accommodation portion 81. Therefore, the oil O sent from the inside of the gear accommodation portion 82 into the motor accommodation portion 81 easily flows into the gear accommodation portion 82 through the partition wall opening 68.

The drive device 1 is provided with the oil passage 90 for circulating the oil O inside the housing 6. The oil passage 90 is a path for supplying the oil O from the oil sump P to the motor 2 and guiding the oil O to the oil sump P again. The oil passage 90 is provided across the inside of the motor accommodation portion 81 and the inside of the gear accommodation portion 82.

In this description, the term “oil passage” means a path of oil. Therefore, the term “oil passage” is a concept including not only a “flow path” that creates a steady unidirectional flow of oil, but also a path for temporarily retaining oil and a path for oil to drip off. The path for temporarily retaining oil includes, for example, a reservoir for storing the oil.

The oil passage 90 has a first oil passage 91 and a second oil passage 92. The first oil passage 91 and the second oil passage 92 each circulate the oil O inside the housing 6. The first oil passage 91 has a scoop path 91a, a shaft supply path 91b, an in-shaft path 91c, and an in-rotor path 91d. A first reservoir 93 is provided in the path of the first oil passage 91. The first reservoir 93 is provided in the gear accommodation portion 82.

The scoop path 91a is a path for scooping the oil O from the oil sump P by rotation of the ring gear 51 of the differential device 5 and receiving the oil O in the first reservoir 93. The first reservoir 93 opens upward. The first reservoir 93 receives the oil O scooped by the ring gear 51. When the liquid level of the oil sump P is high immediately after the motor 2 is driven, the first reservoir 93 also receives the oil O scooped by the second gear 42 and the third gear 43 in addition to the ring gear 51.

The oil O scooped by the ring gear 51 is also supplied to the deceleration device 4 and the differential device 5. Thus, the oil O accommodated in the housing 6 is supplied to the transmission device 3. The oil O supplied to the transmission device 3 is supplied as lubricating oil to the gear of the deceleration device 4 and the gear of the differential device 5. The oil O scooped by the ring gear 51 may be supplied to either the deceleration device 4 or the differential device 5.

The shaft supply path 91b guides the oil O from the first reservoir 93 to the hollow portion 22 of the shaft 21. The in-shaft path 91c is a path for the oil O to pass through the hollow portion 22 of the shaft 21. The in-rotor path 91d is a path passing through the inside of the rotor body 24 from the communication hole 23 of the shaft 21 and scatters to the stator 30.

In the in-shaft path 91c, centrifugal force is applied to the oil O inside the rotor 20 due to the rotation of the rotor 20. Thus, the oil O is continuously scattered radially outward from the rotor 20. With the scattering of the oil O, the path inside the rotor 20 becomes negative pressure, the oil O accumulated in the first reservoir 93 is sucked into the rotor 20, and the path inside the rotor 20 is filled with the oil O.

The oil O having reached the stator 30 absorbs heat from the stator 30. The oil O having cooled the stator 30 is drips to the lower side and accumulated in the lower region in the motor accommodation portion 81. The oil O accumulated in the lower region in the motor accommodation portion 81 moves to the gear accommodation portion 82 through the partition wall opening 68 provided in the partition wall 61c. As described above, the first oil passage 91 supplies the oil O to the rotor 20 and the stator 30.

In the second oil passage 92, the oil O is lifted up from the oil sump P to the upper side of the stator 30 and supplied to the stator 30. That is, the second oil passage 92 supplies the oil O from the upper side of the stator 30 to the stator 30. The second oil passage 92 is provided with the oil pump 96, the oil cooler 97, and a second reservoir 10. The second oil passage 92 has a first flow path 92a, a second flow path 92b, and a third flow path 92c.

The first flow path 92a, the second flow path 92b, and the third flow path 92c are provided on the wall portion of the housing 6. The first flow path 92a connects the oil sump P and the oil pump 96. The second flow path 92b connects the oil pump 96 and the oil cooler 97. The third flow path 92c extends upward from the oil cooler 97. The third flow path 92c is provided in the wall portion of the motor accommodation portion 81. Although not illustrated, the third flow path 92c has a supply port opening inside the motor accommodation portion 81 above the stator 30. The supply port supplies the oil O to the inside of the motor accommodation portion 81.

The oil pump 96 is an electric pump driven by electricity. The oil pump 96 sends the oil O accommodated in the housing 6 to the motor 2. In the present example embodiment, the oil pump 96 sucks up the oil O from the oil sump P via the first flow path 92a, and supplies the oil O to the motor 2 via the second flow path 92b, the oil cooler 97, the third flow path 92c, and the second reservoir 10. As shown in FIG. 1, the oil pump 96 has a motor unit 96a, a pump unit 96b, and a rotation sensor 72. The pump unit 96b is rotated by the motor unit 96a. Although not illustrated, the pump unit 96b has an inner rotor connected to the motor unit 96a and an outer rotor surrounding the inner rotor. The oil pump 96 sends the oil O to the motor 2 by rotating the pump unit 96b by the motor unit 96a.

The rotation sensor 72 can detect the rotation of the pump unit 96b. In the present example embodiment, by detecting the rotation of the motor unit 96a, the rotation sensor 72 can detect the rotation of the pump unit 96b rotated by the motor unit 96a. The type of the rotation sensor 72 is not particularly limited as long as the rotation of the pump unit 96b can be detected. The rotation sensor 72 may be a magnetic sensor, may be a resolver, or may be an optical sensor. If the rotation sensor 72 is a magnetic sensor, the rotation sensor 72 may be a Hall element such as a Hall IC or may be a magnetoresistive element. The rotation sensor 72 may directly detect the rotation of the pump unit 96b. The detection result of the rotation sensor 72 is sent to the controller 70 described later.

As shown in FIG. 2, the oil cooler 97 cools the oil O passing through the second oil passage 92. The second flow path 92b and the third flow path 92c are connected to the oil cooler 97. The second flow path 92b and the third flow path 92c are connected via an internal flow path of the oil cooler 97. As shown in FIG. 1, the refrigerant W cooled by the radiator 110 is supplied to the oil cooler 97 by the refrigerant pump 120 through the refrigerant flow path 150. The oil O passing through the inside of the oil cooler 97 is cooled by heat exchange with the refrigerant W passing through the refrigerant flow path 150. The oil O cooled by the oil cooler 97 is the oil O sent by the oil pump 96. That is, the refrigerant W sent from the refrigerant pump 120 cools the oil O sent by the oil pump 96 in the oil cooler 97.

As shown in FIG. 2, the second reservoir 10 constitutes a part of the second oil passage 92. The second reservoir 10 is positioned inside the motor accommodation portion 81. The second reservoir 10 is positioned above the stator 30. The second reservoir 10 is supported from below by the stator 30, and is provided in the motor 2. The second reservoir 10 is made of, for example, a resin material.

In the present example embodiment, the second reservoir is in the shape of an upward opening gutter. The second reservoir 10 stores the oil O. In the present example embodiment, the second reservoir 10 stores the oil O supplied into the motor accommodation portion 81 via the third flow path 92c. The second reservoir 10 has a supply port 10a for supplying the oil O to the coil ends 33a and 33b. Thus, the oil O stored in the second reservoir 10 can be supplied to the stator 30.

The oil O supplied from the second reservoir 10 to the stator 30 drips to the lower side and accommodated in the lower region in the motor accommodation portion 81. The oil O accumulated in the lower region in the motor accommodation portion 81 moves to the gear accommodation portion 82 through the partition wall opening 68 provided in the partition wall 61c. As described above, the second oil passage 92 supplies the oil O to the stator 30.

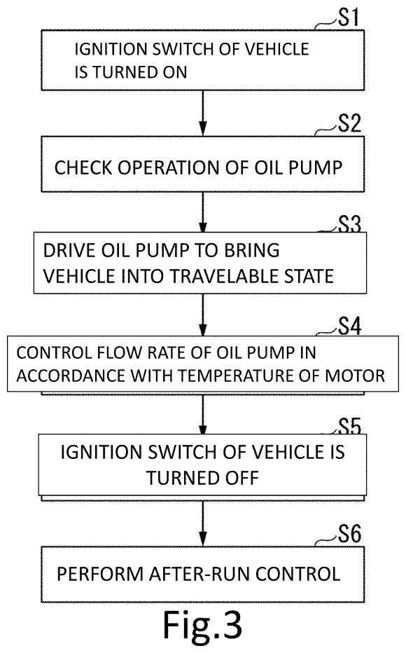

As shown in FIG. 1, the inverter unit 8 has the controller 70. That is, the drive device 1 includes the controller 70. The controller 70 is accommodated in an inverter case 8a. The controller 70 is cooled by the refrigerant W flowing in a part of the refrigerant flow path 150 provided in the inverter case 8a. The controller 70 controls the motor 2 and the motor unit 96a of the oil pump 96. Although not illustrated, the controller 70 has an inverter circuit for adjusting power supplied to the motor 2. In the present example embodiment, the controller 70 performs control according to steps S1 to S6 shown in FIG. 3.

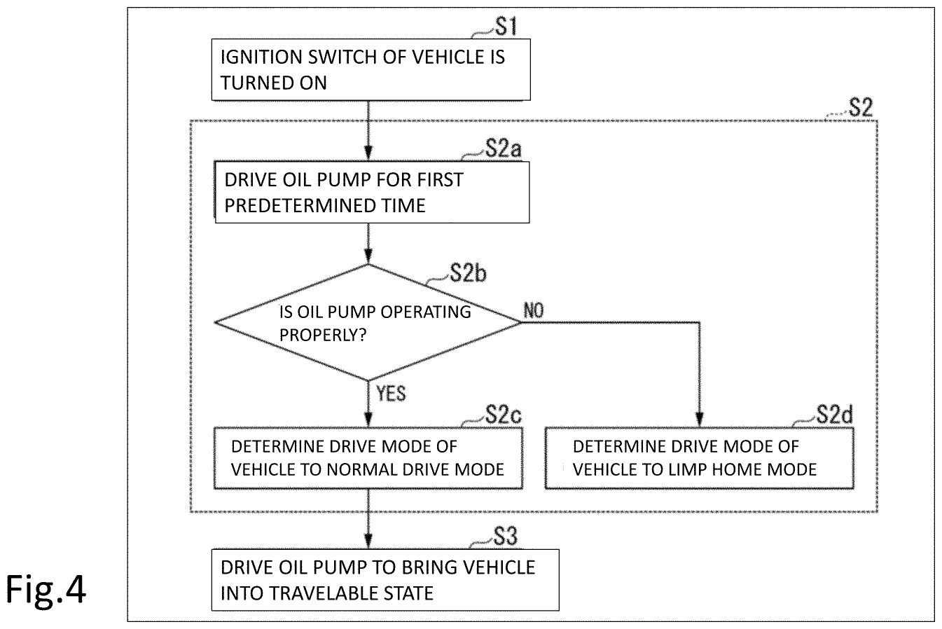

When the ignition switch IGS of the vehicle is turned on in step S1, the controller 70 performs step S2. In step S2, the controller 70 checks the operation of the oil pump 96. As shown in FIG. 4, in the present example embodiment, the operation check by the oil pump 96 in step S2 includes steps S2a to S2d.

In step S2a, the controller 70 drives the oil pump 96 for a first predetermined time. The first predetermined time is, for example, 5 seconds or more and 15 seconds or less. In step S2b, the controller 70 determines whether or not the oil pump 96 is operating normally. Specifically, the controller 70 acquires, based on the rotation sensor 72, the rotational speed of the pump unit 96b when the oil pump 96 is driven for the first predetermined time, and determines whether or not the rotational speed of the pump unit 96b is within a predetermined range. The predetermined range is a range, for example, within about ±10% of the target rotational speed sent from the controller 70 to the oil pump 96 as a command. That is, the predetermined range is a range of the rotational speed of the pump unit 96b that is allowed when a predetermined target rotational speed is input to the oil pump 96, for example.

If the rotational speed of the pump unit 96b is within the predetermined range, the controller 70 determines that the oil pump 96 is operating normally, and performs step S2c. In step S2c, the controller 70 determines the travel mode of the vehicle to the normal travel mode. When the travel mode is determined to be the normal travel mode, the controller 70 performs step S3. In step S3, the controller 70 drives the oil pump 96 to being the vehicle into a travelable state.

On the other hand, in a case where the rotational speed of the pump unit 96b is out of the predetermined range, the controller 70 determines that the oil pump 96 is not operating normally, and performs step S2d. In step S2d, the controller 70 determines the travel mode of the vehicle to a limp home mode. The limp home mode is a mode in which the output of the motor 2 is limited. That is, in the present example embodiment, the controller 70 limits the output of the motor 2 when determining that the operation of the oil pump 96 is abnormal based on the detection result of the rotation sensor 72.

The case where the rotational speed of the pump unit 96b is out of the predetermined range includes a case where the rotational speed of the pump unit 96b is smaller than the predetermined range and a case where the rotational speed of the pump unit 96b is larger than the predetermined range. That is, in the present example embodiment, when the rotational speed of the pump unit 96b when the oil pump 96 is driven for the first predetermined time is different from the target rotational speed input to the oil pump 96 by a predetermined rotational speed or more, the controller 70 determines that the operation of the oil pump 96 is abnormal and limits the output of the motor 2.

Here, the predetermined rotational speed is a value equal to or larger than an error in the rotational speed of the pump unit 96b permitted with respect to the target rotational speed. The predetermined rotational speed is, for example, a value of 10% or more of the target rotational speed. That is, the controller limits the output of the motor 2, for example, when the rotational speed of the pump unit 96b obtained based on the rotation sensor 72 is deviated by 10% or more from the target rotational speed.

In the present example embodiment, the output of the motor 2 limited based on the detection result of the rotation sensor 72 includes the rotational speed of the motor 2 and the torque of the motor 2. By limiting the torque of the motor 2 and the rotational speed of the motor 2, the speed and acceleration of the vehicle are limited. The limitation of the output of the motor 2 in the limp home mode is a limitation such that the temperature of the motor 2 does not rise even if the motor 2 is not cooled by the oil pump 96. That is, in the limp home mode, the rotational speed and torque of the motor 2 are limited to relatively low values, and the speed and acceleration of the vehicle are limited to relatively low values.

When the travel mode is determined to be the limp home mode, the controller 70 brings the vehicle into a travelable state with the output of the motor 2 being limited. At this time, the controller 70 may keep the oil pump 96 not operating normally in a stopping state. In the limp home mode, the controller 70 continues to limit output of the motor 2 until the ignition switch IGS is turned off.

For example, when the oil pump 96 is not operating normally, there is a possibility that a failure occurs in the supply of the oil O to the motor 2 and the cooling of the motor 2 becomes insufficient. Therefore, the temperature of the motor 2 becomes excessively high, and there is a possibility that a failure occurs in the motor 2. In contrast, according to the present example embodiment, as described above, the controller 70 limits output of the motor 2 based on the detection result of the rotation sensor 72. Therefore, when the oil pump 96 is not operating normally, the output of the motor 2 can be limited. When the output of the motor 2 is limited, the heat generation amount in the motor 2 decreases. Thus, even if the oil pump 96 is not operating normally, the temperature of the motor 2 can be suppressed from rising, and the temperature of the motor 2 can be suppressed from becoming excessively high. Therefore, it is possible to suppress a failure from occurring in the motor 2. Since the vehicle can travel while limiting the output of the motor 2, the vehicle can move to a desired place while suppressing the damage of the motor 2.

In the present example embodiment, the controller 70 limits the output of the motor 2 when determining that the operation of the oil pump 96 is abnormal based on the detection result of the rotation sensor 72. Therefore, the output of the motor 2 can be suitably limited according to the operation state of the oil pump 96. Therefore, it is possible to suitably suppress a failure from occurring in the motor 2.

In the present example embodiment, the controller 70 determines that the operation of the oil pump 96 is abnormal and limits the output of the motor 2 when the rotational speed of the pump unit 96b when the oil pump 96 is driven for the first predetermined time is different from the target rotational speed input to the oil pump 96 by a predetermined rotational speed or more. Therefore, the controller 70 can easily determine that the operation of the oil pump 96 is abnormal based on the rotational speed of the pump unit 96b, and can more suitably limit the output of the motor 2. Therefore, it is possible to more suitably suppress a failure from occurring in the motor 2.

According to the present example embodiment, the output of the motor 2 limited based on the detection result of the rotation sensor 72 includes the rotational speed of the motor 2. Therefore, the rotational speed of the motor 2 can be limited relatively low, and the temperature rise of the motor 2 can be more suitably suppressed.

According to the present example embodiment, the output of the motor 2 limited based on the detection result of the rotation sensor 72 includes the torque of the motor 2. Therefore, the torque of the motor 2 can be limited relatively low, and the temperature rise of the motor 2 can be more suitably suppressed.

When the rotational speed of the motor 2 is limited, the oil O is less likely to be scooped by the ring gear 51, and the oil O as lubricating oil becomes less likely to be supplied to the transmission device 3. Therefore, there is a risk that the gears in the transmission device 3 rub against each other and cause seizure. On the other hand, by limiting the torque of the motor 2, it is possible to reduce the load applied between the gears of the transmission device 3. Thus, even if the oil O as lubricating oil is not supplied, the gears are suppressed from rubbing against each other and causing seizure.

As described above, in the present example embodiment, in step S2 immediately after the ignition switch IGS of the vehicle is turned on, the controller 70 checks the operation of the oil pump 96 and determines the travel mode of the vehicle. In other words, in the present example embodiment, the controller 70 determines whether or not to limit the output of the motor 2 immediately after the ignition switch IGS of the vehicle is turned on. Therefore, before the vehicle starts traveling, it is possible to detect the abnormality of the oil pump 96, and it is possible to select the travel mode in which a failure can be suppressed from occurring in the motor 2, i.e., the limp home mode in the present example embodiment.

In this description, “immediately after the ignition switch of the vehicle is turned on” includes a period from when the ignition switch is turned on until when the vehicle is brought into a travelable state.

As shown in FIG. 3, having determined the travel mode of the vehicle to be the normal travel mode, and having brought the vehicle into a travelable state in step S3, the controller 70 next performs step S4. In step S4, the controller 70 controls the flow rate of the oil pump 96 according to the temperature of the motor 2. In the present example embodiment, step S4 is constantly performed until the ignition switch IGS is turned off in step S5 after the vehicle is brought into a travelable state.

In the present example embodiment, the controller 70 controls the oil pump 96 by pulse width modulation (PWM) control. By adjusting the duty ratio of the pulse current supplied to the oil pump 96, the controller 70 controls the output of the oil pump 96 and controls the flow rate of the oil O sent by the oil pump 96. The larger the duty ratio of the pulse current supplied to the oil pump 96 is, the larger the output of the oil pump 96 becomes, and the larger the flow rate of the oil O sent by the oil pump 96 becomes. The smaller the duty ratio of the pulse current supplied to the oil pump 96 is, the smaller the output of the oil pump 96 becomes, and the smaller the flow rate of the oil O sent by the oil pump 96 becomes. The flow rate of the oil O sent by the oil pump 96 is proportional to, for example, the duty ratio of the pulse current supplied to the oil pump 96.

Here, for example, it has been required to more efficiently control the oil pump 96 from the viewpoint of reducing the power consumption of the drive device 1, suitably cooling the motor 2, and the like. On the other hand, according to the present example embodiment, the controller 70 is provided in the inverter unit 8, and the detection result of the temperature sensor 71 is sent to the controller 70. That is, the oil pump 96 can be directly controlled by the controller 70 to which the detection result of the temperature sensor 71 is sent. Therefore, for example, the responsiveness of control of the oil pump 96 based on the temperature of the motor 2 can be improved as compared with a case where the detection result of the temperature sensor 71 is sent from the controller 70 to the vehicle control device 140 and the control of the oil pump 96 is performed by the vehicle control device 140. As a result, the oil pump 96 can be controlled more efficiently as compared with the case where the control of the oil pump 96 is performed by the vehicle control device 140. Therefore, the power consumption of the drive device 1 can be reduced, and the motor 2 can be suitably cooled by the oil pump 96.

The drive device 1 may include a flow rate sensor that can detect the flow rate of the oil O sent from the oil pump 96. In this case, based on the detection result of the flow rate sensor, the controller 70 may adjust the output of the oil pump 96 and adjust the flow rate of the oil O sent from the oil pump 96 to a desired flow rate.

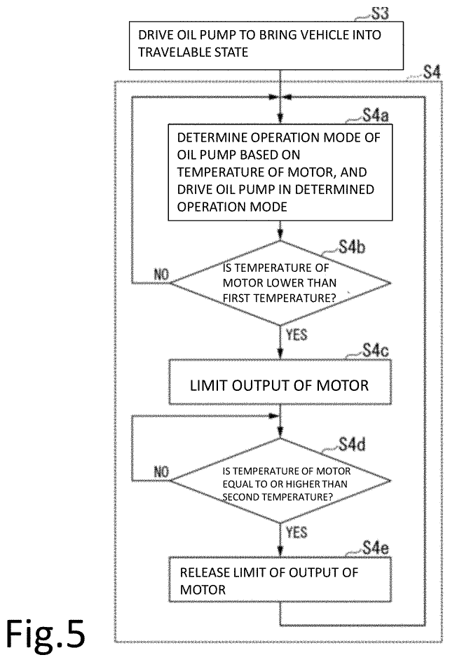

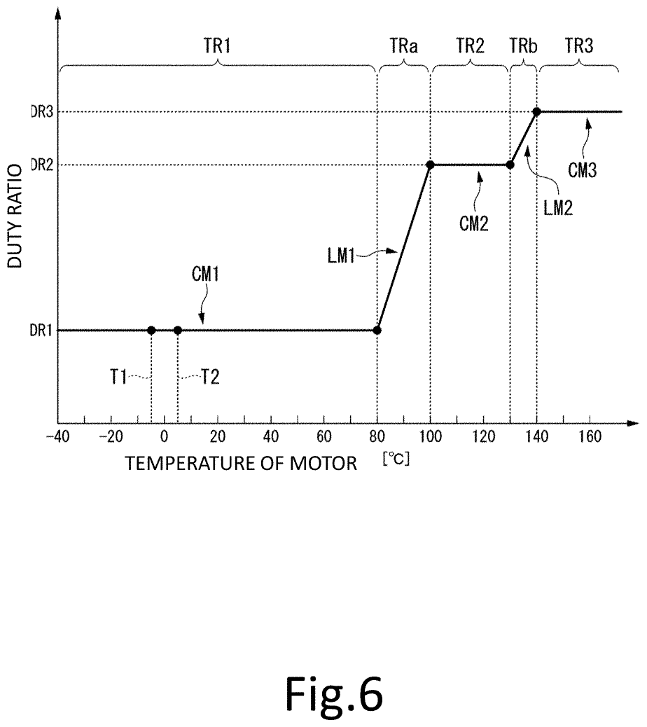

As shown in FIG. 5, the flow rate control of the oil pump 96 in step S4 of the present example embodiment includes steps S4a to S4e. In step S4a, the controller 70 determines an operation mode of the oil pump 96 based on the temperature of the motor 2, and drives the oil pump 96 in the determined operation mode. Specifically, the controller 70 acquires the temperature of the motor 2 based on the temperature sensor 71, and determines the operation mode of the oil pump 96 based on the temperature of the motor 2. As shown in FIG. 6, in the present example embodiment, the operation mode of the oil pump 96 includes a first mode CM1, a second mode CM2, a third mode CM3, a first linear change mode LM1, and a second linear change mode LM2.

In the present example embodiment, when the temperature of the motor 2 obtained based on the temperature sensor 71 is within a predetermined first temperature range TR1, the controller 70 sets the operation mode of the oil pump 96 to the first mode CM1. In the example of FIG. 6, the first temperature range TR1 is a temperature range of 80° C. or lower. In the first mode CM1, the controller 70 sets the duty ratio of the pulse current sent to the oil pump 96, for example, to a constant value DR1. When the duty ratio of the pulse current supplied to the oil pump 96 is the value DR1, the flow rate of the oil O sent by the oil pump 96 is a first flow rate, for example. The first flow rate is a predetermined flow rate as a flow rate of the oil O sent to the motor 2, for example, when the vehicle travels in a normal state.

In the present example embodiment, when the temperature of the motor 2 obtained based on the temperature sensor 71 is a temperature within a second temperature range TR2, the controller 70 sets the operation mode of the oil pump 96 to the second mode CM2. The second temperature range TR2 is a temperature range in which the temperature is higher than that in the first temperature range TR1. The second temperature range TR2 is narrower than the first temperature range TR1, for example. In the example of FIG. 6, the second temperature range TR2 is a temperature range of 100° C. or more and 130° C. or less.

In the present example embodiment, the first temperature range TR1 and the second temperature range TR2 are provided at an interval with each other. In the present example embodiment, the difference between the minimum temperature in the second temperature range TR2 and the maximum temperature in the first temperature range TR1 is 5° C. or more and 30° C. or less. More specifically, in the present example embodiment, the difference between the minimum temperature in the second temperature range TR2 and the maximum temperature in the first temperature range TR1 is 10° C. or more and 20° C. or less. In the example of FIG. 6, the maximum temperature in the first temperature range TR1 is 80° C., and the minimum temperature in the second temperature range TR2 is 100° C. That is, in the example of FIG. 6, the difference between the minimum temperature in the second temperature range TR2 and the maximum temperature in the first temperature range TR1 is 20° C.

In the second mode CM2, the controller 70 sets the duty ratio of the pulse current supplied to the oil pump 96, for example, to a constant value DR2. The value DR2 is a value higher than the value DR1. When the duty ratio of the pulse current supplied to the oil pump 96 is the value DR2, the flow rate of the oil O sent by the oil pump 96 is, for example, a second flow rate larger than the first flow rate. Thus, the output of the oil pump 96 in the second mode CM2 is larger than the output of the oil pump 96 in the first mode CM1.

In the present example embodiment, when the temperature of the motor 2 obtained based on the temperature sensor 71 is a temperature within a third temperature range TR3, the controller 70 sets the operation mode of the oil pump 96 to the third mode CM3. The third temperature range TR3 is a temperature range in which the temperature is higher than that in the second temperature range TR2. The third temperature range TR3 is, for example, wider than the second temperature range TR2. In the example of FIG. 6, the third temperature range TR3 is a temperature range of 140° C. or higher.

In the present example embodiment, the second temperature range TR2 and the third temperature range TR3 are provided at an interval with each other. In the present example embodiment, the difference between the minimum temperature in the third temperature range TR3 and the maximum temperature in the second temperature range TR2 is 5° C. or more and 30° C. or less. More specifically, in the present example embodiment, the difference between the minimum temperature in the third temperature range TR3 and the maximum temperature in the second temperature range TR2 is 10° C. or more and 20° C. or less. In the example of FIG. 6, the maximum temperature in the second temperature range TR2 is 130° C., and the minimum temperature in the third temperature range TR3 is 140° C. That is, in the example of FIG. 6, the difference between the minimum temperature in the third temperature range TR3 and the maximum temperature in the second temperature range TR2 is 10° C.

In the third mode CM3, the controller 70 sets the duty ratio of the pulse current supplied to the oil pump 96, for example, to a constant value DR3. The value DR3 is a value higher than the value DR2. The difference between the value DR3 and the value DR2 is, for example, smaller than the difference between the value DR2 and the value DR1. When the duty ratio of the pulse current supplied to the oil pump 96 is the value DR3, the flow rate of the oil O sent by the oil pump 96 is, for example, a third flow rate larger than the second flow rate. As described above, the output of the oil pump 96 in the third mode CM3 is larger than the output of the oil pump 96 in the second mode CM2.

As described above, according to the present example embodiment, the first mode CM1, the second mode CM2, and the third mode CM3 are provided as the operation mode of the oil pump 96, and the output of the oil pump 96 increases in the order of the first mode CM1, the second mode CM2, and the third mode CM3. The controller 70 sets the operation mode of the oil pump 96 to the first mode CM1 when the temperature of the motor 2 is within the first temperature range TR1, sets the operation mode of the oil pump 96 to the second mode CM2 when the temperature of the motor 2 is within the second temperature range TR2 higher than the first temperature range TR1, and sets the operation mode of the oil pump 96 to the third mode CM3 when the temperature of the motor 2 is within the third temperature range TR3 higher than the second temperature range TR2. Therefore, when the temperature of the motor 2 becomes high, the operation mode of the oil pump 96 is switched to the operation mode in which the output of the oil pump 96 is large. As a result, when the temperature of the motor 2 becomes high, the flow rate of the oil O sent to the motor 2 can be suitably increased. Therefore, the motor 2 can be suitably cooled. In addition, since the output of the oil pump 96 can be reduced when the temperature of the motor 2 becomes low, the oil pump 96 can be driven with high energy efficiency. That is, the oil pump 96 can be controlled more efficiently.

Each temperature range in which each operation mode of the oil pump 96 described above is executed is determined based on, for example, a change in the temperature of the motor 2 caused by a change in the travel state of the vehicle equipped with the drive device 1. The first temperature range TR1 is determined based on, for example, a temperature range of the motor 2 when the vehicle travels on a flat land in an environment where the air temperature is ordinary temperatures or less. The second temperature range TR2 is determined based on, for example, the temperature range of the motor 2 when the vehicle travels on an uphill in an environment where the air temperature is ordinary temperatures or less. The third temperature range TR3 is determined based on, for example, the temperature range of the motor 2 when the vehicle travels on an uphill in an environment where the air temperature is higher than the ordinary temperatures. The ordinary temperatures is, for example, a temperature range of 5° C. or more and 35° C. or less defined in JIS Z 8703.

Thus, by determining the temperature range in which each operation mode is executed based on the temperature change of the motor 2 caused by the change in the travel state of the vehicle, the number of operation modes of the oil pump 96 can be easily reduced as compared with the case where the operation mode is provided for each predetermined temperature width, for example, every 10° C. Therefore, switching between the operation modes of the oil pump 96 is less likely to occur than a case where the operation mode is provided for each predetermined temperature width. As a result, the output of the oil pump 96 can be suppressed from changing frequently, and a load can be less likely to be applied to the oil pump 96. Therefore, the oil pump 96 can be controlled more efficiently.

In the present example embodiment, when the temperature of the motor 2 obtained based on the temperature sensor 71 is a temperature within a first intermediate temperature range TRa, the controller 70 sets the operation mode of the oil pump 96 to the first linear change mode LM1. The first intermediate temperature range TRa is a temperature range higher in temperature than the first temperature range TR1 and lower in temperature than the second temperature range TR2. That is, the first intermediate temperature range TRa is a temperature range between the first temperature range TR1 and the second temperature range TR2. The first intermediate temperature range TRa is narrower than the second temperature range TR2, for example. In the example of FIG. 6, the first intermediate temperature range TRa is a temperature range higher than 80° C. and lower than 100° C.

In the first linear change mode LM1, the controller 70 linearly changes, according to the temperature change of the motor 2, the duty ratio of the pulse current supplied to the oil pump 96. The duty ratio of the pulse current supplied to the oil pump 96 in the first linear change mode LM1 linearly increases from the value DR1 of the duty ratio in the first mode CM1 to the value DR2 of the duty ratio in the second mode CM2 as the temperature of the motor 2 increases from the maximum temperature in the first temperature range TR1 toward the minimum temperature in the second temperature range TR2.

Thus, in the present example embodiment, when the temperature of the motor 2 obtained based on the temperature sensor 71 is higher than the first temperature range TR1 and lower than the second temperature range TR2, the controller 70 linearly raises the output of the oil pump 96 as the temperature of the motor 2 obtained based on the temperature sensor 71 increases. Therefore, when the temperature of the motor 2 lies in between the first temperature range TR1 and the second temperature range TR2, the flow rate of the oil O sent from the oil pump 96 to the motor 2 can be suitably controlled according to the temperature of the motor 2. This allows the motor 2 to be cooled more suitably. Furthermore, the oil pump 96 can be driven with high energy efficiency.

Furthermore, by providing the first intermediate temperature range TRa, the first temperature range TR1 and the second temperature range TR2 are provided at an interval. Therefore, even if the temperature of the motor 2 slightly fluctuates, the operation mode of the oil pump 96 is less likely to be switched between the first mode CM1 and the second mode CM2. This can suppress frequent switching between the first mode CM1 and the second mode CM2 in a short time, for example. Therefore, it is possible to further suppress a load from applying to the oil pump 96, and to suppress the operation of the oil pump 96 from becoming unstable.

According to the present example embodiment, the difference between the minimum temperature in the second temperature range TR2 and the maximum temperature in the first temperature range TR1 is 5° C. or more and 30° C. or less. Therefore, the first intermediate temperature range TRa can be set to a suitable range. Specifically, the first intermediate temperature range TRa can be suppressed from becoming too narrow. Therefore, even if the temperature of the motor 2 slightly fluctuates, the operation mode of the oil pump 96 can be less likely to be switched between the first mode CM1 and the second mode CM2. Thus, it is possible to more suitably suppress a load from applying to the oil pump 96 and to further suppress the operation of the oil pump 96 from becoming unstable. In addition, the first intermediate temperature range TRa can be suppressed from becoming too wide. Therefore, when the temperature of the motor 2 changes to a certain extent, for example, it is possible to suppress the responsiveness from deteriorating when the operation mode of the oil pump 96 is switched between the first mode CM1 and the second mode CM2.

The difference between the minimum temperature in the second temperature range TR2 and the maximum temperature in the first temperature range TR1 is more preferably 10° C. or more and 20° C. or less. By setting the difference between the minimum temperature in the second temperature range TR2 and the maximum temperature in the first temperature range TR1 within such a numerical range, it is possible to more preferably suppress a load from applying to the oil pump 96 and to further suppress the operation of the oil pump 96 from becoming unstable. It is possible to further suppress a decrease in responsiveness when the operation mode of the oil pump 96 is switched between the first mode CM1 and the second mode CM2.

In the present example embodiment, when the temperature of the motor 2 obtained based on the temperature sensor 71 is a temperature within a second intermediate temperature range TRb, the controller 70 sets the operation mode of the oil pump 96 to the second linear change mode LM2. The second intermediate temperature range TRb is a temperature range higher in temperature than the second temperature range TR2 and lower in temperature than the third temperature range TR3. That is, the second intermediate temperature range TRb is a temperature range between the second temperature range TR2 and the third temperature range TR3. The second intermediate temperature range TRb is narrower than the second temperature range TR2 and the first intermediate temperature range TRa, for example. In the example of FIG. 6, the second intermediate temperature range TRb is a temperature range higher than 130° C. and lower than 140° C. In the present example embodiment, the first temperature range TR1, the first intermediate temperature range TRa, the second temperature range TR2, the second intermediate temperature range TRb, and the third temperature range TR3 are provided continuously in this order.

In the second linear change mode LM2, the controller 70 linearly changes, according to the temperature change of the motor 2, the duty ratio of the pulse current supplied to the oil pump 96. The duty ratio of the pulse current supplied to the oil pump 96 in the second linear change mode LM2 linearly increases from the value DR2 of the duty ratio in the second mode CM2 to the value DR3 of the duty ratio in the third mode CM3 as the temperature of the motor 2 increases from the maximum temperature in the second temperature range TR2 toward the minimum temperature in the third temperature range TR3. Thus, in the present example embodiment, when the temperature of the motor 2 obtained based on the temperature sensor 71 is higher than the second temperature range TR2 and lower than the third temperature range TR3, the controller 70 linearly raises the output of the oil pump 96 as the temperature of the motor 2 obtained based on the temperature sensor 71 increases.

Thus, in the present example embodiment, when the temperature of the motor 2 obtained based on the temperature sensor 71 is higher than the second temperature range TR2 and lower than the third temperature range TR3, the controller 70 linearly raises the output of the oil pump 96 as the temperature of the motor 2 obtained based on the temperature sensor 71 increases. Therefore, when the temperature of the motor 2 lies in between the second temperature range TR2 and the third temperature range TR3, the flow rate of the oil O sent from the oil pump 96 to the motor 2 can be suitably controlled according to the temperature of the motor 2. This allows the motor 2 to be cooled more suitably. Furthermore, the oil pump 96 can be driven with high energy efficiency.

Furthermore, by providing the second intermediate temperature range TRb, the second temperature range TR2 and the third temperature range TR3 are provided at an interval. Therefore, even if the temperature of the motor 2 slightly fluctuates, the operation mode of the oil pump 96 is less likely to be switched between the second mode CM2 and the third mode CM3. This can suppress frequent switching between the second mode CM2 and the third mode CM3 in a short time, for example. Therefore, it is possible to further suppress a load from applying to the oil pump 96, and to suppress the operation of the oil pump 96 from becoming unstable.

According to the present example embodiment, the difference between the minimum temperature in the third temperature range TR3 and the maximum temperature in the second temperature range TR2 is 5° C. or more and 30° C. or less. Therefore, the second intermediate temperature range TRb can be set to a suitable range. Specifically, the second intermediate temperature range TRb can be suppressed from becoming too narrow. Therefore, even if the temperature of the motor 2 slightly fluctuates, the operation mode of the oil pump 96 can be less likely to be switched between the second mode CM2 and the third mode CM3. Thus, it is possible to more suitably suppress a load from applying to the oil pump 96 and to further suppress the operation of the oil pump 96 from becoming unstable. In addition, the second intermediate temperature range TRb can be suppressed from becoming too wide. Therefore, when the temperature of the motor 2 changes to a certain extent, for example, it is possible to suppress the responsiveness from deteriorating when the operation mode of the oil pump 96 is switched between the second mode CM2 and the third mode CM3.

The difference between the minimum temperature in the third temperature range TR3 and the maximum temperature in the second temperature range TR2 is more preferably 10° C. or more and 20° C. or less. By setting the difference between the minimum temperature in the third temperature range TR3 and the maximum temperature in the second temperature range TR2 within such a numerical range, it is possible to more preferably suppress a load from applying to the oil pump 96 and to further suppress the operation of the oil pump 96 from becoming unstable. It is possible to further suppress a decrease in responsiveness when the operation mode of the oil pump 96 is switched between the second mode CM2 and the third mode CM3.

As shown in FIG. 5, in step S4b, the controller 70 determines whether or not the temperature of the motor 2 obtained based on the temperature sensor 71 is lower than a predetermined first temperature T1. The first temperature T1 is a temperature within the first temperature range TR1. The value of the first temperature T1 is, for example, −20° C. or higher and −5° C. or lower. In the example of FIG. 6, the value of the first temperature T1 is −5° C.

If determining in step S4b that the temperature of the motor 2 is equal to or higher than the first temperature T1, the controller 70 repeats step S4a. On the other hand, if determining in step S4b that the temperature of the motor 2 is lower than the first temperature T1, the controller 70 performs step S4c. In step S4c, the controller 70 limits the output of the motor 2. That is, in the present example embodiment, the controller 70 limits the output of the motor 2 when the temperature of the motor 2 obtained based on the temperature sensor 71 is lower than the predetermined first temperature T1 in the first temperature range TR1.

In the present example embodiment, the output of the motor 2 limited based on the detection result of the temperature sensor 71 includes the torque of the motor 2 and the torque change rate of the motor 2. By limiting the torque of the motor 2 and the torque change rate of the motor 2, acceleration and a rapid rise of the acceleration of the vehicle are limited. In the present example embodiment, the limitation of the output of the motor 2 based on the detection result of the temperature sensor 71 is a limitation such that the seizure of the gears can be suppressed even if the oil O as lubricating oil is not supplied in meshing of the gears in the deceleration device 4 and the differential device 5.

Here, when the temperature of the motor 2 is relatively low, the environment in which the vehicle travels is relatively low in temperature. Therefore, the oil O accommodated in the housing 6 is relatively low in temperature and the viscosity of the oil O becomes relatively high. When the viscosity of the oil O becomes too high, the oil O supplied to the transmission device 3 becomes less likely to form an oil film between gears meshing with each other. Since the oil O is less likely to be scooped by the ring gear 51, the amount of the oil O itself supplied to the transmission device 3 becomes reduced. As a result, there has been a risk that the gears in the transmission device 3 are rubbed against each other to cause seizure.

In contrast, according to the present example embodiment, as described above, the controller 70 limits the output of the motor 2 based on the detection result of the temperature sensor 71. Therefore, by limiting the output of the motor 2 when the environment in which the vehicle travels is relatively low in temperature, it becomes possible to reduce the load applied between the gears of the transmission device 3. Thus, it is possible to suppress the occurrence of seizure by rubbing the gears in the transmission device 3. Therefore, it is possible to suppress a failure from occurring in the drive device 1 under a relatively low temperature environment.

In the present example embodiment, the controller 70 limits the output of the motor 2 when the temperature of the motor 2 obtained based on the temperature sensor 71 is lower than the predetermined first temperature T1. Therefore, it is possible to limit the output of the motor 2 under a relatively low temperature environment, and it is possible to suppress a failure from occurring in the drive device 1.

According to the present example embodiment, the output of the motor 2 limited based on the detection result of the temperature sensor 71 includes the torque of the motor 2. Therefore, it is possible to reduce a load applied between the gears of the transmission device 3, and it is possible to suitably suppress the gears from rubbing each other and causing seizure.

According to the present example embodiment, the output of the motor 2 limited based on the detection result of the temperature sensor 71 includes the torque change rate of the motor 2. This suppresses torque of the motor 2 from suddenly rising, and can suppress gears meshing with each other in the transmission device 3 from strongly colliding with each other. This can more suitably suppress the gears of the transmission device 3 from causing seizure.

In the present example embodiment, the output of the motor 2 limited based on the detection result of the temperature sensor 71 does not include the rotational speed of the motor 2. Thus, in a relatively low temperature environment, the vehicle acceleration is limited while the vehicle speed is not. Thus, the vehicle speed can be gradually increased. Therefore, the vehicle can travel smoothly while suppressing a failure from occurring in the drive device 1.

In the present example embodiment, the first temperature range TR1 also includes a temperature lower than the first temperature T1. That is, in the present example embodiment, even if the temperature of the motor 2 becomes lower than the first temperature T1, the oil pump 96 continues to operate in the first mode CM1. As a result, the oil O continues to circulate in the drive device 1 by the oil pump 96 even under a relatively low temperature environment. Therefore, the oil O can be supplied to the transmission device 3 by the oil pump 96 even under a relatively low temperature environment. Therefore, it is possible to further suppress the occurrence of seizure by rubbing the gears in the transmission device 3. Furthermore, as the oil O circulates in the drive device 1, heat generated in the motor 2 or the like is applied to the oil O. Therefore, the temperature of the oil O can be suppressed from becoming too low, and the viscosity of the oil O can be suppressed from becoming too high.

As shown in FIG. 5, after limiting the output of the motor 2 in step S4c, the controller 70 performs step S4d. In step S4d, the controller 70 determines whether or not the temperature of the motor 2 obtained based on the temperature sensor 71 is equal to or higher than a second temperature T2. The second temperature T2 is higher than the first temperature T1. The second temperature T2 is a temperature within the first temperature range TR1. The value of the second temperature T2 is, for example, −10° C. or higher and 5° C. or lower. In the example of FIG. 6, the value of the second temperature T2 is 5° C.

If determining in step S4d that the temperature of the motor 2 is lower than the second temperature T2, the controller 70 maintains the state in which the output of the motor 2 is limited. On the other hand, if determining in step S4d that the temperature of the motor 2 is equal to or higher than the second temperature T2, the controller 70 performs step S4e. In step S4e, the controller 70 releases the limitation of the output of the motor 2. That is, in the present example embodiment, after limiting the output of the motor 2, when the temperature of the motor 2 obtained based on the temperature sensor 71 is equal to or higher than the second temperature T2, the controller 70 releases the limitation of the output of the motor 2.

Here, when the temperature of the motor 2 becomes relatively high, the temperature of the entire drive device 1 also rises due to heat generation from the motor 2. Therefore, the temperature of the oil O also rises, and the viscosity of the oil O becomes relatively low. Thus, it is possible to suitably provide an oil film between meshing gears in the transmission device 3. Therefore, it is possible to suppress the gear from causing seizure even when the limitation of the output of the motor 2 is released.

The case where the temperature of the motor 2 becomes relatively high includes a case where the temperature of the environment in which the vehicle travels rises, and a case where the temperature of the motor 2 rises as the rotational speed of the motor 2 rises while the environment in which the vehicle travels remains relatively low.

After step S4e, the controller 70 returns the processing to step S4a. Thereafter, the controller 70 repeatedly executes steps S4a to S4e in step S4 described above until the ignition switch IGS is turned off. In steps S4c, S4d, and S4e, the operation mode of the oil pump 96 is the first mode CM1.

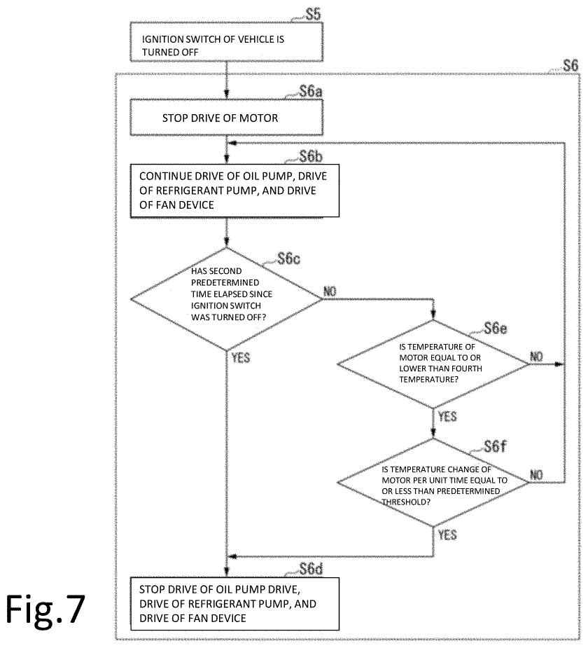

As shown in FIG. 3, when the ignition switch IGS of the vehicle is turned off in step S5, the controller 70 performs step S6. In step S6, the controller 70 performs after-run control. As shown in FIG. 7, after-run control in step S6 of the present example embodiment includes steps S6a to S6f. In step S6a, the controller 70 stops drive of the motor 2.

Next, in step S6b, the controller 70 drives the oil pump 96, the refrigerant pump 120, and the fan device 130. That is, in the present example embodiment, the controller 70 drives the oil pump 96 after the ignition switch IGS of the vehicle is turned off. Therefore, the oil O is sent to the motor 2 by the oil pump 96, thereby cooling the motor 2. Therefore, the motor 2 can be cooled after the ignition switch IGS is turned off.

Here, in the vehicle equipped with the drive device 1, after the ignition switch IGS is turned off, the ignition switch is sometimes turned on again at a relatively short interval. In this case, when the ignition switch is turned on again, the temperature of the motor 2 mounted on the drive device 1 sometimes remains relatively high. After the ignition switch IGS is turned on again, the output from the drive device 1 is not sometimes suitably obtained. Specifically, for example, the temperature of the motor 2 sometimes quickly becomes high, and the output of the motor 2 such as torque is sometimes limited. In this case, there is a case where the acceleration of the vehicle cannot be suitably obtained after the ignition switch IGS is turned on again.

On the other hand, according to the present example embodiment, as described above, the controller 70 can cool the motor 2 by driving the oil pump 96 after the ignition switch IGS of the vehicle is turned off. Therefore, the temperature of the motor 2 can be kept relatively low before the ignition switch is turned on again at a relatively short interval. Therefore, even when the ignition switch IGS is turned on at a relatively short interval after the ignition switch IGS is turned off, the output from the drive device 1 can be suitably obtained.

According to the present example embodiment, the controller 70 drives the oil pump 96, the refrigerant pump 120, and the fan device 130 after the ignition switch IGS of the vehicle is turned off. Thus, the refrigerant W in the radiator 110 is cooled by the fan device 130, and the cooled refrigerant W is sent to the oil cooler 97 by the refrigerant pump 120. The oil O cooled by the refrigerant W in the oil cooler 97 is sent to the motor 2 by the oil pump 96, whereby the motor 2 is more suitably cooled. Therefore, the motor 2 can be more suitably cooled after the ignition switch IGS is turned off. Therefore, the temperature of the motor 2 can be kept more suitable low before the ignition switch is turned on again at a relatively short interval. Thus, even when the ignition switch IGS is turned on at a relatively short interval after the ignition switch IGS is turned off, the output from the drive device 1 can be obtained more suitably.

In step S6b, the controller 70 continues to drive the equipment being driven when the ignition switch IGS was turned off among the oil pump 96, the refrigerant pump 120, and the fan device 130. On the other hand, in step S6b, the controller 70 starts driving, immediately after the ignition switch IGS is turned off, the equipment stopped when the ignition switch IGS was turned off among the oil pump 96, the refrigerant pump 120, and the fan device 130. For example, in the state where the ignition switch IGS is turned on in the present example embodiment, the oil pump 96, the refrigerant pump 120, and the fan device 130 are in a driven state. Therefore, in step S6b, the controller 70 continues drive of the oil pump 96, drive of the refrigerant pump 120, and drive of the fan device 130.

In step S6b of the present example embodiment, the controller 70 transmits, to the vehicle control device 140, a signal for the vehicle control device 140 to drive the refrigerant pump 120 and the fan device 130. Thus, the vehicle control device 140 drives the refrigerant pump 120 and the fan device 130. That is, in the present example embodiment, after the ignition switch IGS is turned off, the controller 70 drives the refrigerant pump 120 and the fan device 130 via the vehicle control device 140.

Next, in step S6c, the controller 70 determines whether or not a second predetermined time has elapsed since the ignition switch IGS was turned off. The second predetermined time is, for example, 10 seconds or more and 40 seconds or less. The second predetermined time is such a time that the temperature change of the motor 2 does not occur when the motor 2 is cooled by driving the oil pump 96, the refrigerant pump 120, and the fan device 130 in a state where the drive of the motor 2 is stopped. The second predetermined time is, for example, a value obtained in advance by an experiment or the like.

If determining in step S6c that the second predetermined time has elapsed, the controller 70 performs step S6d. In step S6d, the controller 70 stops the drive of the oil pump 96, the drive of the refrigerant pump 120, and the drive of the fan device 130. That is, if a predetermined time has elapsed after the ignition switch IGS is turned off, the controller 70 stops the drive of the oil pump 96, the drive of the refrigerant pump 120, and the drive of the fan device 130. In the present example embodiment, the controller 70 stops the drive of the refrigerant pump 120 and the drive of the fan device 130 via the vehicle control device 140 in the same manner as in the case of driving.

On the other hand, if determining in step S6c that the second predetermined time has not elapsed, the controller 70 performs step S6e. In step S6e, the controller 70 determines whether or not the temperature of the motor 2 obtained based on the temperature sensor 71 is equal to or lower than a fourth temperature. The fourth temperature is a relatively high temperature. The value of the fourth temperature is, for example, the same as the value of the third temperature described above. The value of the fourth temperature may be different from the value of the third temperature.

If determining in step S6e that the temperature of the motor 2 is higher than the fourth temperature, the controller 70 continues the drive of the oil pump 96, the drive of the refrigerant pump 120, and the drive of the fan device 130. Thus, the temperature of the motor 2 can be made equal to or lower than the fourth temperature.

On the other hand, if determining in step S6e that the temperature of the motor 2 is equal to or lower than the fourth temperature, the controller 70 performs step S6f. In step S6f, the controller 70 determines whether or not the temperature change of the motor 2 per unit time is equal to or less than a predetermined threshold. The predetermined threshold is, for example, about several ° C.

The temperature change of the motor 2 per unit time can include a case in which the temperature of the motor 2 rises and a case in which the temperature of the motor 2 drops. For example, in a case where the ignition switch IGS is turned off immediately after the output of the motor 2 suddenly increases, the temperature of the motor 2 may rise with some lag after the drive of the motor 2 is stopped.

If determining in step S6f that the temperature change of the motor 2 per unit time is greater than the predetermined threshold, the controller 70 continues the drive of the oil pump 96, the drive of the refrigerant pump 120, and the drive of the fan device 130. Thus, when the temperature change per unit time is relatively large, cooling of the motor 2 can be continued.

On the other hand, if determining in step S6f that the temperature change of the motor 2 per unit time is equal to or less than the predetermined threshold, the controller 70 stops in step S6d the drive of the oil pump 96, the drive of the refrigerant pump 120, and the drive of the fan device 130. Thus, the after-run control in step S6 ends.

According to the present example embodiment, as in steps S6c, S6e, and S6f described above, after the ignition switch IGS is turned off, the controller 70 stops the drive of the oil pump 96, the drive of the refrigerant pump 120, and the drive of the fan device 130 based on the detection result of the temperature sensor 71. Therefore, the oil pump 96, the refrigerant pump 120, and the fan device 130 are driven to suitably cool the motor 2 until the temperature of the motor 2 suitably drops. Thus, even when the ignition switch IGS is turned on at a relatively short interval after the ignition switch IGS is turned off, the output from the drive device 1 can be obtained more suitably.

According to the present example embodiment, as in step S6f described above, when the temperature of the motor 2 obtained based on the temperature sensor 71 is a predetermined temperature, i.e., the fourth temperature or less, and the temperature change of the motor 2 per unit time is a predetermined threshold or less after the ignition switch IGS is turned off, the controller 70 stops the drive of the oil pump 96, the drive of the refrigerant pump 120, and the drive of the fan device 130. Therefore, even if the temperature of the motor 2 becomes relatively low, the cooling of the motor 2 can be ended when the temperature of the motor 2 comes to not change while the cooling of the motor 2 is continued while the temperature of the motor 2 fluctuates relatively largely. Thus, after the ignition switch IGS is turned off, the motor 2 is easily cooled to the maximum extent possible to be cooled by the oil pump 96 or the like, and it is possible to suppress the oil pump 96 or the like from being excessively continued to drive. Therefore, in the after-run control after the ignition switch IGS is turned off, the temperature of the motor 2 can be suitably lowered and the power consumption can be reduced.

For example, if a failure occurs in the temperature sensor 71, even if the actual temperature of the motor 2 is sufficiently low, there is a possibility that the temperature of the motor 2 obtained based on the temperature sensor 71 is different from the actual temperature and does not satisfy the stop condition described above. In this case, the oil pump 96, the refrigerant pump 120, and the fan device 130 are driven more than necessary, and power consumption in the after-run control is likely to increase.

On the other hand, according to the present example embodiment, if the second predetermined time has elapsed after the ignition switch IGS is turned off, the controller 70 stops the drive of the oil pump 96, the drive of the refrigerant pump 120, and the drive of the fan device 130. Therefore, even when a failure occurs in the temperature sensor 71, the drive of the oil pump 96, the drive of the refrigerant pump 120, and the drive of the fan device 130 can be stopped after the second predetermined time. Thus, the oil pump 96, the refrigerant pump 120, and the fan device 130 can be prevented from being driven more than necessary, and the power consumption in the after-run control can be prevented from increasing.

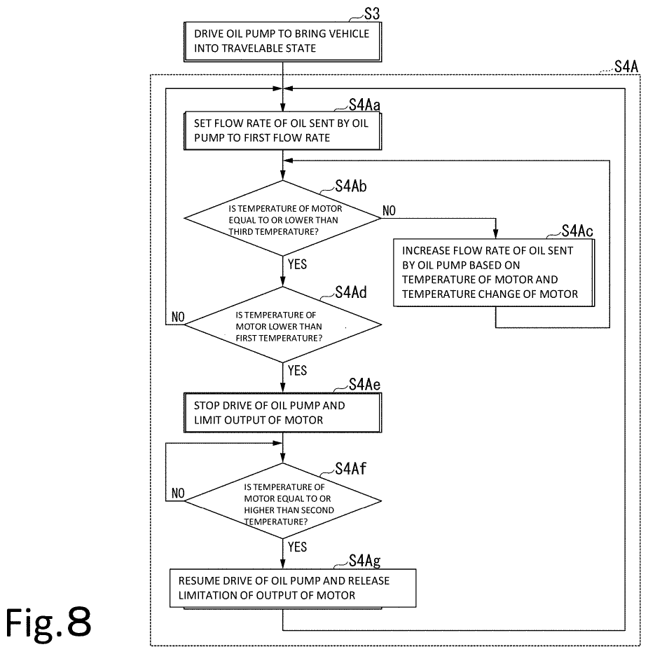

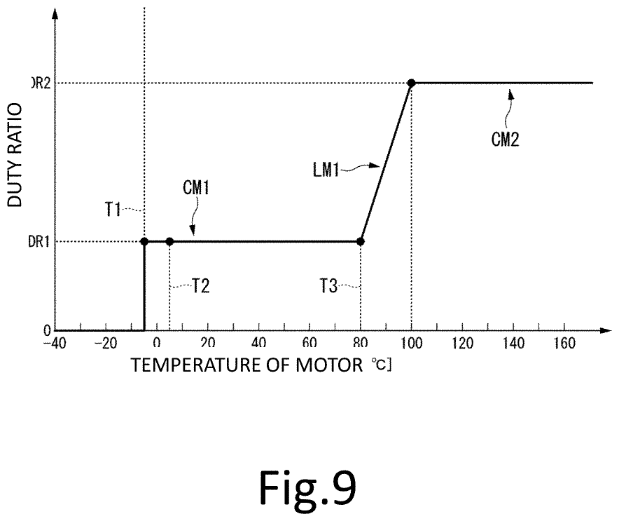

As shown in FIG. 8, the flow rate control of the oil pump 96 in step S4 of the present example embodiment includes steps S4Aa to S4Ag. As shown in FIG. 9, in the present example embodiment, the operation mode of the oil pump 96 includes a first mode CM1, a second mode CM2, and a first linear change mode LM1. In the present example embodiment, the operation mode of the oil pump 96 does not include the third mode CM3 and the second linear change mode LM2 unlike the first example embodiment. As shown in FIG. 8, in step S4Aa, the controller 70 sets the operation mode of the oil pump 96 to the first mode CM1, and sets the oil O flow rate sent by the oil pump 96 to the first flow rate.

Next, in step S4Ab, the controller 70 determines whether or not the temperature of the motor 2 is equal to or lower than a third temperature T3. The third temperature T3 is a relatively high temperature. The value of the third temperature T3 is, for example, 80° C. or higher and 100° C. or lower. In the example of FIG. 9, the value of the third temperature T3 is, for example, 80° C.

If determining in step S4Ab that the temperature of the motor 2 is higher than the third temperature T3, the controller 70 performs step S4Ac. In step S4Ac, the controller 70 increases the flow rate of the oil O sent by the oil pump 96 based on the temperature of the motor 2 and the temperature change of the motor 2. Thus, when the temperature of the motor 2 is relatively high, it is possible to increase the flow rate of the oil O sent to the motor 2, and it is possible to suitably cool the motor 2.

Specifically, in step S4Ac, when the temperature change of the motor 2 per unit time is equal to or less than the predetermined value, the controller 70 sets the operation mode of the oil pump 96 to the first linear change mode LM1, and linearly changes the flow rate of the oil O sent by the oil pump 96 in accordance with the temperature of the motor 2 from the first flow rate to the second flow rate. This makes it possible to adjust an increase amount of the oil O sent to the motor 2 according to the temperature of the motor 2. Therefore, the motor 2 can be suitably cooled with high energy efficiency.

On the other hand, in step S4Ac, if the temperature change of the motor 2 per unit time is greater than a predetermined value, the controller 70 shifts the operation mode of the oil pump 96 from the first mode CM1 to the second mode CM2 without passing through the first linear change mode LM1. Thus, the controller 70 sets the flow rate of the oil O sent by the oil pump 96 to the second flow rate greater than the first flow rate. Therefore, a sudden temperature rise of the motor 2 can be suppressed, and the motor 2 can be suitably cooled.

The graph shown in FIG. 9 shows a case where the temperature change of the motor 2 per unit time is equal to or less than a predetermined value in step S4Ac. If the temperature change of the motor 2 per unit time is greater than a predetermined value in step S4Ac, the first linear change mode LM1 is not provided, and the temperature range of the motor 2 in which the first mode CM1 is executed and the temperature range of the motor in which the second mode CM2 is executed are continuously provided with the third temperature T3 as a boundary.

As shown in FIG. 8, if determining in step S4Ab that the temperature of the motor 2 is equal to or lower than the third temperature T3, the controller 70 performs step S4Ad. In step S4Ad, the controller 70 determines whether or not the temperature of the motor 2 obtained based on the temperature sensor 71 is lower than a predetermined first temperature T1. The first temperature T1 is a temperature lower than the third temperature T3. The value of the first temperature T1 is, for example, −20° C. or higher and −5° C. or lower.

If determining in step S4Ad that the temperature of the motor 2 is equal to or higher than the first temperature T1, the controller 70 maintains, at the first flow rate, the flow rate of the oil O sent from the oil pump 96 to the motor 2 in step S4Aa, or returns it to the first flow rate, and then performs the step S4Ab again.

On the other hand, if determining in step S4Ad that the temperature of the motor 2 is lower than the first temperature T1, the controller 70 performs step S4Ae. In step S4Ae, the controller 70 stops drive of the oil pump 96 and limits the output of the motor 2. That is, in the present example embodiment, the controller 70 stops the drive of the oil pump 96 when the temperature of the motor 2 obtained based on the temperature sensor 71 is lower than the predetermined first temperature T1. Thus, in the present example embodiment, the first mode CM1 is executed when the temperature of the motor 2 is within the temperature range equal to or higher than the first temperature T1 and equal to or less than the third temperature T3.

According to the present example embodiment, the controller 70 stops drive of the oil pump 96 when the temperature of the motor 2 obtained based on the temperature sensor 71 is lower than the predetermined first temperature T1. If the viscosity of the oil O is relatively high in a relatively low temperature environment, it becomes difficult for the oil pump 96 to send the oil O to the motor 2, and the load of the oil pump 96 increases. Therefore, by stopping the drive of the oil pump 96, it is possible to suppress a large load from being applied to the oil pump 96, and it is possible to reduce power consumption in the drive device 1. On the other hand, since the temperature of the motor 2 is relatively low, even if the oil O is not sent by the oil pump 96, the motor 2 is suppressed from causing a failure due to heat. Accordingly, by stopping the drive of the oil pump 96 when the temperature of the motor 2 is relatively low, it is possible to reduce the power consumption of the drive device 1 while suppressing a failure from occurring in the motor 2.

As shown in FIG. 8, after limiting the output of the motor 2 in step S4Ae, the controller 70 performs step S4Af. In step S4Af, the controller 70 determines whether or not the temperature of the motor 2 obtained based on the temperature sensor 71 is equal to or higher than a second temperature T2. The second temperature T2 is a temperature higher than the first temperature T1 and lower than the third temperature T3. The value of the second temperature is, for example, −10° C. or higher and 5° C. or lower.

If determining in step S4Af that the temperature of the motor 2 is lower than the second temperature T2, the controller 70 stops drive of the oil pump 96 and maintains the state in which the output of the motor 2 is limited. On the other hand, if determining in step S4Af that the temperature of the motor 2 is equal to or higher than the second temperature T2, the controller 70 performs step S4Ag. In step S4Ag, the controller 70 resumes the drive of the oil pump 96 and releases the limitation of the output of the motor 2. That is, in the present example embodiment, after limiting the output of the motor 2, when the temperature of the motor 2 obtained based on the temperature sensor 71 is equal to or higher than the second temperature T2, the controller 70 resumes the drive of the oil pump 96 and releases the limitation of the output of the motor 2.

Here, if the temperature of the motor 2 becomes relatively high, the viscosity of the oil O becomes relatively low, and hence the oil O can be easily sent by the oil pump 96. Therefore, even if the drive of the oil pump 96 is resumed, the load applied to the oil pump 96 can be made relatively small. The motor 2 can be suitably cooled by the oil O sent from the oil pump 96.

After step S4Ag, the controller 70 returns the processing to step S4Aa. That is, the flow rate of the oil O sent by the oil pump 96 when the drive is resumed in step S4Ag of the present example embodiment is set to the first flow rate. Thereafter, the controller 70 repeatedly executes steps S4Aa to S4Ag in step S4A described above until the ignition switch IGS is turned off.

The present disclosure is not limited to the example embodiment described above, but other configurations and methods can be employed. When the output of the motor is limited based on the detection result of the rotation sensor, the controller of the drive device may limit the output of the motor by any procedure and condition. For example, the controller may determine that the operation of the oil pump is abnormal and limit the output of the motor when the rotational speed of the pump unit obtained based on the rotation sensor fluctuates irregularly. The output of the motor limited based on the detection result of the rotation sensor is not particularly restricted and may include the torque change rate of the motor, may not include the rotational speed of the motor, and may not include the torque of the motor. The operation check of the oil pump by the controller may be performed other than immediately after the ignition switch of the vehicle is turned on. The operation check of the oil pump by the controller may be periodically performed from when the ignition switch of the vehicle is turned on to when the ignition switch is turned off. The controller may not limit the output of the motor based on the detection result of the rotation sensor.

When limiting the output of the motor based on the detection result of the temperature sensor, the controller of the drive device may limit the output of the motor by any procedure and condition. For example, the controller may limit the output of the motor when the temperature of the motor obtained based on the temperature sensor is relatively high. The output of the motor limited based on the detection result of the temperature sensor is not particularly restricted and may include the rotational speed of the motor, may not include the torque of the motor, and may not include the torque change rate of the motor. The controller may not stop the drive of the oil pump when limiting the output of the motor based on the detection result of the temperature sensor. When the temperature of the motor obtained based on the temperature sensor is equal to or higher than the first temperature and lower than the second temperature, the controller may stop the drive of the oil pump without limiting the output of the motor. In this case, the controller may resume the drive of the oil pump when the temperature of the motor becomes equal to or higher than the second temperature, and may limit the output of the motor when the temperature of the motor becomes lower than the first temperature.

The controller of the drive device may not limit the output of the motor based on the detection result of the temperature sensor. For example, the controller 70 of the first example embodiment described above may not limit the output of the motor 2 in step S4. In this case, step S4 does not include steps S4b to S4e, and includes only step S4a, for example.

The controller of the drive device may drive the oil pump under any procedure and condition when the oil pump, the refrigerant pump, and the fan device are driven after the ignition switch of the vehicle is turned off. For example, the controller may drive the oil pump, the refrigerant pump, and, the fan device after a certain period of time has elapsed after the ignition switch of the vehicle is turned off. The controller may not drive the refrigerant pump and the fan device after the ignition switch of the vehicle is turned off. The controller may stop the drive of the oil pump, the drive of the refrigerant pump, and the drive of the fan device under any condition after the ignition switch of the vehicle is turned off. The controller may stop the drive of the oil pump, the drive of the refrigerant pump, and the drive of the fan device regardless of the temperature of the motor after the ignition switch of the vehicle is turned off. The controller may not drive the oil pump after the ignition switch of the vehicle is turned off.

Each configuration and method described in this description can be combined as appropriate within a scope that does not give rise to mutual contraction.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-13. (canceled)

14: A drive device that rotates an axle of a vehicle, the drive device comprising:
a motor;
a transmission that includes a decelerator that is connected to the motor;
a housing that accommodates the motor and the transmission;
a temperature sensor to detect a temperature of the motor; and
a controller to control the motor; wherein
oil supplied to the transmission is accommodated in the housing; and
the controller is configured or programmed to limit an output of the motor based on a detection result of the temperature sensor.

15: The drive device according to claim 14, wherein an output of the motor limited based on a detection result of the temperature sensor includes a torque of the motor.

16: The drive device according to claim 14, wherein an output of the motor limited based on a detection result of the temperature sensor includes a torque change rate of the motor.

17: The drive device according to claim 14, further comprising:
an oil pump to send oil accommodated in the housing to the motor; wherein
the controller is configured or programmed to:
set an operation mode of the oil pump to a first mode when a temperature of the motor obtained based on the temperature sensor is a temperature within a predetermined first temperature range;
set an operation mode of the oil pump to a second mode when the temperature of the motor obtained based on the temperature sensor is a temperature within a second temperature range higher than the first temperature range; and
set an operation mode of the oil pump to a third mode when the temperature of the motor obtained based on the temperature sensor is a temperature within a third temperature range higher than the second temperature range;
an output of the oil pump in the second mode is larger than an output of the oil pump in the first mode; and
an output of the oil pump in the third mode is larger than an output of the oil pump in the second mode.

18: A drive device that rotates an axle of a vehicle, the drive device comprising:
a motor;
a transmission that includes a decelerator that is connected to the motor;
a housing that accommodates the motor, the transmission, and oil;
a temperature sensor to detect a temperature of the motor;
a controller to control the motor; and
an oil pump to send the oil accommodated in the housing to the motor; wherein
the controller is configured or programmed to:
set an operation mode of the oil pump to a first mode when a temperature of the motor obtained based on the temperature sensor is a temperature within a predetermined first temperature range,
set an operation mode of the oil pump to a second mode when the temperature of the motor obtained based on the temperature sensor is a temperature within a second temperature range higher than the first temperature range; and
set an operation mode of the oil pump to a third mode when the temperature of the motor obtained based on the temperature sensor is a temperature within a third temperature range higher than the second temperature range;
an output of the oil pump in the second mode is larger than an output of the oil pump in the first mode; and
an output of the oil pump in the third mode is larger than an output of the oil pump in the second mode.

19: The drive device according to claim 17, wherein, when the temperature of the motor obtained based on the temperature sensor is higher than the first temperature range and lower than the second temperature range, the controller is configured or programmed to linearly raise an output of the oil pump as a temperature of the motor obtained based on the temperature sensor increases.

20: The drive device according to claim 19, wherein a difference between a minimum temperature in the second temperature range and a maximum temperature in the first temperature range is about 5° C. or more and about 30° C. or less.

21: The drive device according to claim 17, wherein when a temperature of the motor obtained based on the temperature sensor is higher than the second temperature range and lower than the third temperature range, the controller is configured or programmed to linearly raise an output of the oil pump as a temperature of the motor obtained based on the temperature sensor increases.

22: The drive device according to claim 21, wherein a difference between a minimum temperature in the third temperature range and a maximum temperature in the second temperature range is about 5° C. or more and about 30° C. or less.

23: The drive device according to claim 17, wherein the controller is configured or programmed to limit an output of the motor when the temperature of the motor obtained based on the temperature sensor is lower than a predetermined first temperature in the first temperature range.

24: The drive device according to claim 18, wherein the controller is configured or programmed to limit an output of the motor when the temperature of the motor obtained based on the temperature sensor is lower than a predetermined first temperature.

25: The drive device according to claim 24, further comprising:
an oil pump to send oil accommodated in the housing to the motor; wherein
the controller is configured or programmed to stop driving the oil pump when the temperature of the motor obtained based on the temperature sensor is lower than the first temperature.

26: The drive device according to claim 25, wherein after limiting an output of the motor, the controller is configured or programmed to resume drive of the oil pump and releases limitation of an output of the motor when the temperature of the motor obtained based on the temperature sensor is equal to or higher than a second temperature higher than the first temperature.

27: The drive device according to claim 18, wherein when the temperature of the motor obtained based on the temperature sensor is higher than the first temperature range and lower than the second temperature range, the controller is configured or programmed to linearly raise an output of the oil pump as a temperature of the motor obtained based on the temperature sensor increases.

28: The drive device according to claim 27, wherein a difference between a minimum temperature in the second temperature range and a maximum temperature in the first temperature range is about 5° C. or more and about 30° C. or less.

29: The drive device according to claim 27, wherein when the temperature of the motor obtained based on the temperature sensor is higher than the second temperature range and lower than the third temperature range, the controller is configured or programmed to linearly raise an output of the oil pump as the temperature of the motor obtained based on the temperature sensor increases.

30: The drive device according to claim 29, wherein a difference between a minimum temperature in the third temperature range and a maximum temperature in the second temperature range is about 5° C. or more and about 30° C. or less.

31: The drive device according to claim 27, wherein the controller is configured or programmed to limit an output of the motor when the temperature of the motor obtained based on the temperature sensor is lower than a predetermined first temperature in the first temperature range.

32: The drive device according to claim 27, wherein the controller is configured or programmed to limit an output of the motor when the temperature of the motor obtained based on the temperature sensor is lower than a predetermined first temperature.

33: The drive device according to claim 32, further comprising:
an oil pump that sends oil accommodated in the housing to the motor; wherein
the controller is configured or programmed to stop driving the oil pump when a temperature of the motor obtained based on the temperature sensor is lower than the first temperature.

34: The drive device according to claim 33, wherein after limiting an output of the motor, the controller is configured or programmed to resume drive of the oil pump and releases limitation of an output of the motor when the temperature of the motor obtained based on the temperature sensor is equal to or higher than a second temperature higher than the first temperature.
